(19) United States
(12) Patent Application Publication
(10) Pub. No.: US 2023/0275490 A1
(43) Pub. Date: Aug. 31, 2023

(54) DISHWASHER DIVERTER VALVE DRIVE

(71) Applicant: ILLINOIS TOOL WORKS INC., Glenview, IL (US)

(72) Inventors: Corey M. PRUESS, Racine, WI (US); John STEWART, Germantown, WI (US); Mason ELKHOURY, Bloomingdale, IL (US)

(73) Assignee: ILLINOIS TOOL WORKS INC., Glenview, IL (US)

(21) Appl. No.: 18/114,359

(22) Filed: Feb. 27, 2023

Related U.S. Application Data
(60) Provisional application No. 63/314,733, filed on Feb. 28, 2022.

(51) Int. Cl. H02K 7/10; F16K 31/04; H02K 5/04

(52) U.S. Cl. CPC H02K 7/10; F16K 31/043; H02K 5/04

(57) ABSTRACT

An AC motor, and method of operation, including a synchronous motor with a magnetic rotor, and a stator positioned at a fixed distance from the magnetic rotor. A no-back mechanism is configured to oscillate when the synchronous motor is rotating in a desired direction, and the no-back component is configured to move to a stopping position when the synchronous motor is rotating in an undesired direction.

### CROSS REFERENCE TO RELATED APPLICATION

This application claims the benefit of U.S. Provisional Application, Ser. No. 63/314,733, filed on 28 Feb. 2022. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates to a synchronous motor, and more particularly to a motor used to drive a diverter valve of a dishwasher during a dishwashing process.

### Description of Prior Art

Dishwashers include a multitude of working parts in order to operate and provide an automated dishwashing process. Many dishwashers utilize AC synchronous motors to operate. An AC synchronous motor is an electric motor driven by an alternating current (AC). Such a motor is synchronous when a rotation period of the motor is equal to a number of AC cycles.

AC synchronous motors typically have asymmetry in stator parts. Stator parts include stationary components of electromagnetic circuits in motors. Some dishwasher motors may include a no-back feature that is used whenever a single rotational direction is required. Designs often put a no-back feature down a gear train of the dishwasher motor so as to avoid a hard stop on a rotor assembly of the motor. The rotor is therefore free to rotate in either direction until it is stopped by the no-back feature. Gear windup can help the motor start running in a desired direction. In order for these no-back features to be successful, they must be inherently stronger than other components to withstand an increase in force applied farther down the gear train of a dishwasher motor.

There is a need to improve dishwasher motors to operate efficiently and to reduce or eliminate excessive force on the various dishwater motor components.

### SUMMARY OF THE INVENTION

The general object of the invention can be attained, at least in part, through a dishwasher diverter valve drive that includes a no-back feature located at or near a rotor of a dishwasher motor. The subject invention removes a no-back feature from a gear train (as in the prior art), which reduces or eliminates the need for the no-back feature to withstand excessive force.

The motor of the subject invention includes a stator, such as integrated into a motor cup. The stator or motor cup preferably includes a plurality of apertures to allow a no-back feature to be positioned in an area less affected by force than with previous systems. The dishwasher diverter valve also includes a rotor assembly foot that can be molded without the need to control magnetized poles within the motor. As such, the no-back feature of the subject invention does not require further modifications to avoid a force “dead zone.”

The invention includes an AC motor including a synchronous motor with a magnetic rotor, and a stator positioned at a fixed distance from the magnetic rotor. A no-back component is configured to oscillate when the synchronous motor is rotating in a desired direction, and the no-back component is configured to move to a stopping position when the synchronous motor is rotating in an undesired direction.

In embodiments of this invention, a motor cup at least partially encloses the rotor and stator, and can be covered by cover component. The no-back component is desirably connected to a surface of the motor cup. The no-back component can include an attachment element connected to a connection point on or in the surface of the motor cup.

In preferred embodiments, the motor cup includes a plurality of apertures, each of the apertures configured for receiving an attachment element (e.g., oscillation stem) of the no-back component. The apertures are desirably disposed about a rotor shaft axis, wherein each of the plurality of apertures is configured to fix the no-back element at a different angle relative to the rotor and/or stator.

The rotor includes a contact component, such as fixed to a rotation axis rotor shaft. The no-back component catches on the contact component when rotating in the undesired direction. The contact component can also contact a contoured inner surface of the no-back component in the desired direction to cause an oscillating movement of the no-back component in the desired direction. This oscillating movement allows the components to by-pass each other in the desired direction and catch in the undesired direction.

In embodiments of this invention, the outer surface of the no-back component contacts a stationary portion of the synchronous motor on opposing sides to control the oscillating movement. The outer surface of the no-back component can include at least one extension that contacts a motor cup housing to control the oscillating movement. The motor cup can include a recess for the no-back component.

The invention further includes an AC synchronous motor including a housing embodied as a motor cup, a magnetic rotor within the motor cup, and a stator within the motor cup and positioned at a fixed distance from the magnetic rotor. A no-back component is connected between the motor cup and the rotor, such as between an end of the rotor and a surface of the motor cup, and preferably with a recessed portion of the motor cup end wall. The no-back component is configured to oscillate when the rotor is rotating in a desired direction, and the no-back component is configured to rotate to a stopping position when the rotor is rotating in an undesired direction.

The no-back component includes an attachment element engaged in an aperture of the surface of the motor cup. A plurality of apertures are disposed in the motor cup about a rotor shaft axis, and each of the plurality of apertures is configured to fix the no-back element at a different angle relative to the rotor and/or stator.

A contact component is desirably disposed on a rotor shaft, and the no-back component catches on a first surface of the contact component when rotating in the desired direction. A catch surface extends outward relative the rotor shaft. A second surface of the contact component contacts a contoured inner surface of the no-back component in the desired direction to oscillate the no-back component when the rotor rotates in the desired direction. An outer surface of the no-back component desirably contacts a stationary portion, such as a recessed portion, of the motor cup on an opposing sides to limit an oscillating movement.

The invention further includes a method of operating an AC synchronous motor, including steps of rotating a rotor with respect to a stator within a motor cup in a first and desired direction, and catching the rotor with a no-back component connected between the motor cup and the rotor when the rotor is rotating in a second and undesired direction. The method desirably further includes oscillating the no-back component when the rotor is rotating in the first and desired direction, and rotating the no-back component to a stopping position when the rotor is rotating in the second and undesired direction.

Other objects and advantages will be apparent to those skilled in the art from the following detailed description taken in conjunction with the appended claims and drawings.

### BRIEF DESCRIPTION OF THE DRAWINGS

FIG. 1 shows a top perspective view of a dishwasher diverter valve drive according to one embodiment of the invention;

FIG. 2 shows a bottom perspective view of the dishwasher diverter valve drive according to the embodiment shown in FIG. 1;

FIG. 3 shows a top, partially transparent view of the dishwasher diverter valve drive according to the embodiment shown in FIG. 1;

FIG. 4 shows a sectional view of the dishwasher diverter valve drive according to the embodiment shown in FIGS. 1; and

FIG. 5 shows a partial view of a motor cup of the dishwasher diverter valve drive according to the embodiment shown in FIG. 1.

### DETAILED DESCRIPTION OF THE INVENTION

The present invention provides a motor, such as for dishwasher diverter valve for a dishwasher.

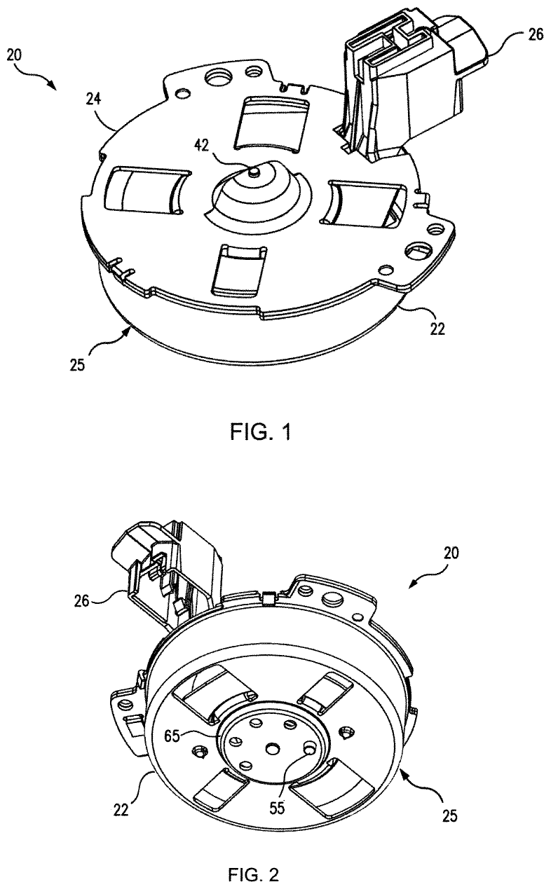

FIGS. 1 and 2 show an AC motor 20, embodied as a synchronous motor assembly 25, for a dishwasher diverter valve according to one embodiment of this invention. The motor assembly 25 includes a motor housing or motor cup 22, which contains the motor components discussed below in an enclosure space closed by top 24. The motor assembly 25 further includes an electrical plug 26 for receiving power for an internal stator 30. The motor 20 preferably includes a permanent magnet rotor 40 with coil windings 44 disposed within the stator 30, and which rotates about a rotor shaft 42 axis upon application of alternating current.

The rotor assembly 40 is preferably symmetrical with equally spaced north and south poles. The stator 30 is preferably made of a ferrous material positioned at a fixed distance from the rotor assembly 40. Contrary to the rotor assembly 40, the stator material is not symmetrical. This asymmetry is needed to get the rotor 40 to start spinning. This asymmetry can also create “dead spots” where there is very little rotational force present when alternating current is applied to the coil of the motor 20.

Application of electrical power causes the rotor 40 to rotate in the desired direction to rotate shaft 42 and actuate the diverter valve (or other component as needed). In order to prevent the motor 20 from rotating in the opposite direction, a no-back mechanism is added to the motor assembly 25. The no-back-mechanism acts as a stop in the opposite, undesired rotation direction, and desirably includes a pair of elements and/or surfaces that make contact to stop the rotor from the second, undesired direction. In embodiments of this invention, the elements/surfaces do not make a stopping contact with each other in the desired direction due to a movement (e.g., oscillation) of the no-back mechanism, such as rotation about the motor cup connection element 55 caused by a follower structure on a cam surface within the no-back mechanism.

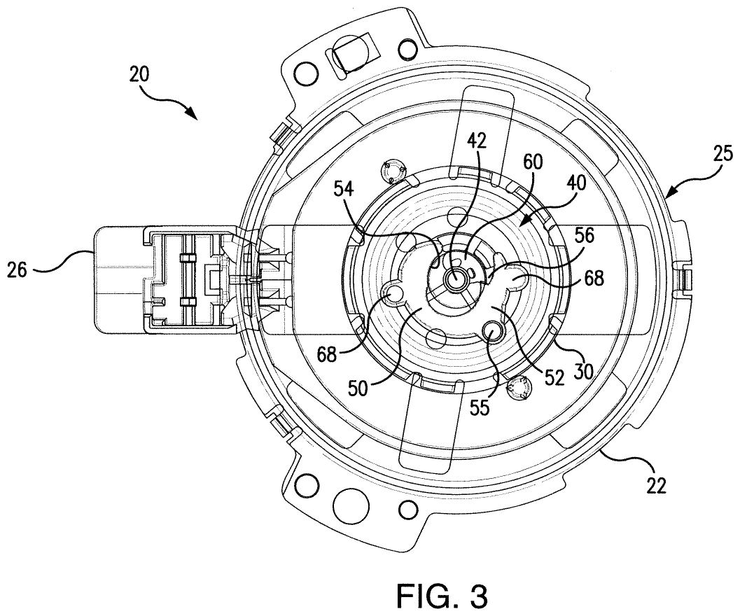

FIG. 3 shows a view of the motor 20 according to one embodiment of the invention where the motor 20 has a no-back mechanism 50. The no-back mechanism 50 of embodiments of this invention oscillates back and forth when the motor is rotating in a desired direction. If and when the motor rotates in an undesired direction, the no-back feature rotates into a stopping position with a contact surface that stops the rotor of the motor.

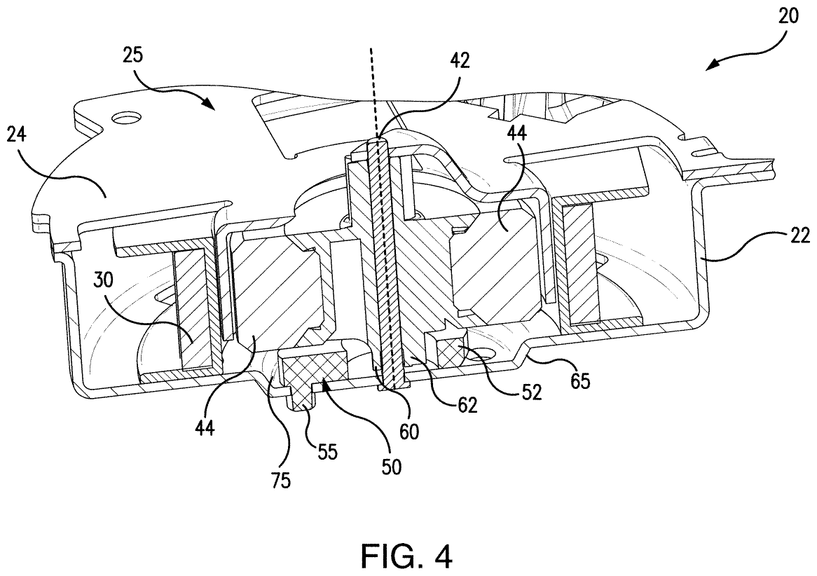

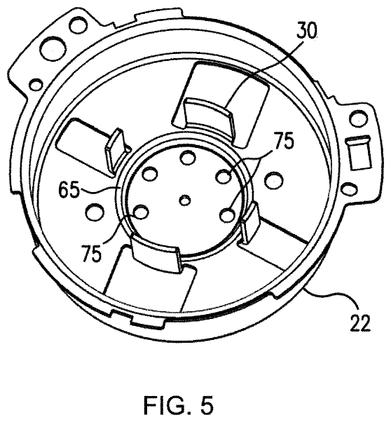

The no-back mechanism 50 shown in FIG. 3 includes a no-back component 52 connected to a bottom surface 28 of the motor cup 22, in a recessed cup portion 65. In the illustrated embodiment, an extension, e.g., stem 52, fits and rotates within an opening 25 in the surface 28. As will be appreciated, other suitable connections can be used between the no-back component 52 and the motor cup 22. The no-back component 52 oscillates back and forth as contact element 60 follows an internal cam surface 54. As shown in FIGS. 3 and 4, the contact element 60 is fixed to the rotor shaft 42, and rotates with the rotor shaft 42.

Upon rotation in the undesired, reverse direction, a catch surface 56 of the no-back component 52 catches on a corresponding surface 62 of the contact element 60 to halt backward rotation. In the desired rotation direction, a second surface 64 of the contact element 60 contacts and follows the internal cam surface 54 of the no-back component 52. Changes in internal cam surface 54, such as raised areas, moves the no-back component 52 back and forth in an oscillating movement to allow the contact element 60 to pass around the no-back component 52 in the desired rotation direction. The outer surface of the no-back component 52 can include extensions 68 to limit the oscillation movement by contacting surfaces within the motor cup 22, such as side walls in recess 65.

FIG. 5 shows a motor cup 22 according to one embodiment of the invention. The motor cup may be integrated with, and thus also considered, the stator 30. As shown, the motor cup 22 has five different locating apertures 70 (although other quantities and arrangements of apertures may be desired). These apertures 70 represent five locations for the no-back component 52. Each aperture 75 provides a slightly different angle, relative the motor cup 22 and/or stator 30, where a rotor contact element 60 can engage the no-back component 52 in relation to magnetized poles of the rotor. This allows the rotor assembly to be made without a fixed angle between the rotor foot and the magnetic poles.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An AC motor comprising:
a synchronous motor;
a magnetic rotor;
a no-back component, wherein the no-back component is configured to oscillate when the synchronous motor is rotating in a desired direction, and wherein the no-back component is configured to move to a stopping position when the synchronous motor is rotating in an undesired direction; and
a stator positioned at a fixed distance from the magnetic rotor.

2. The AC motor of claim 1, further comprising:
a motor cup at least partially enclosing the rotor and stator, wherein the no-back component is connected to a surface of the motor cup.

3. The AC motor of claim 2, wherein the no-back component includes an attachment element connected to a connection point on or in the surface of the motor cup.

4. The AC motor of claim 1, further comprising:
a motor cup comprising a plurality of apertures, wherein the no-back component is attached in one selected aperture of the plurality of apertures.

5. The AC motor of claim 4, wherein the plurality of apertures is disposed about a rotor shaft axis, and each of the plurality of apertures is configured to fix the no-back element at a different angle relative to the rotor and/or stator.

6. The AC motor of claim 1, wherein the rotor comprises a contact component, and the no-back component catches on the contact component when rotating in the undesired direction.

7. The AC motor of claim 6, wherein the contact component contacts a contoured inner surface of the no-back component in the desired direction and causes an oscillating movement of the no-back component in the desired direction.

8. The AC motor of claim 7, wherein the contact component is fixed to a rotor shaft.

9. The AC motor of claim 7, wherein an outer surface of the no-back component contacts a stationary portion of the synchronous motor on opposing sides to control the oscillating movement.

10. The AC motor of claim 9, wherein the outer surface of the no-back component includes at least one extension that contacts a motor housing to control the oscillating movement.

11. An AC synchronous motor, comprising:
a housing comprising a motor cup;
a magnetic rotor within the motor cup;
a stator within the motor cup and positioned at a fixed distance from the magnetic rotor; and
a no-back component connected between the motor cup and the rotor, wherein the no-back component is configured to oscillate when the rotor is rotating in a desired direction, and wherein the no-back component is configured to rotate to a stopping position when the rotor is rotating in an undesired direction.

12. The AC motor of claim 11, wherein the no-back component is connected between an end of the rotor and a surface of the motor cup.

13. The AC motor of claim 12, wherein the no-back component includes an attachment element engaged in an aperture of the surface of the motor cup.

14. The AC motor of claim 11, wherein a plurality of apertures are disposed in the motor cup about a rotor shaft axis, and each of the plurality of apertures is configured to fix the no-back element at a different angle relative to the rotor and/or stator.

15. The AC motor of claim 11, wherein the rotor comprises a contact component disposed on a rotor shaft, and the no-back component catches on a first surface of the contact component when rotating in the undesired direction.

16. The AC motor of claim 15, wherein a second surface of the contact component contacts a contoured inner surface of the no-back component in the desired direction to oscillate the no-back component when the rotor rotates in the desired direction.

17. The AC motor of claim 16, wherein the contact component is fixed to a rotor shaft, and includes a catch surface extending outward from the rotor shaft.

18. The AC motor of claim 16, wherein an outer surface of the no-back component contacts a stationary portion of the motor cup on an opposing sides to limit an oscillating movement.

19. A method of operating an AC synchronous motor, the method comprising:
rotating a rotor with respect to a stator within a motor cup in a first and desired direction;
catching the rotor with a no-back component connected between the motor cup and the rotor when the rotor is rotating in a second and undesired direction.

20. The method of claim 19, further comprising:
oscillating the no-back component when the rotor is rotating in the first and desired direction; and
rotating the no-back component to a stopping position when the rotor is rotating in the second and undesired direction.
